(19) United States
(12) Patent Application Publication
(10) Pub. No.: US 2010/0325937 A1
(43) Pub. Date: Dec. 30, 2010

(54) FISHING APPARATUS

(76) Inventor: Richard Webb, Eire (IE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/918,600

(22) PCT Filed: Feb. 19, 2009
(86) PCT No.: PCT/GB09/00446

§ 371 Date: Aug. 20, 2010

(30) Foreign Application Priority Data
Feb. 20, 2008 (GB) 0803090.0

(51) Int. Cl. A01K 85/00

(52) U.S. Cl. 43/42.36

(57) ABSTRACT

A bait assembly for fishing, e.g. leisure fishing, is described. The bait assembly comprises a hook coupled to a rearward end of a line. A bait body is slideably or detachably mounted with respect to the line so that in normal use a flexible section of the line extends into the bait body. The bait body may comprise an artificial lure, or may comprises a skewer onto which dead bait may be mounted. A retaining mechanism is arranged between the bait body and the line to bias the bait body in a forward position on the line relative to the hook. Thus when a pulling force is applied between the bait body and the line which overcomes the biasing action of the retaining mechanism, the bait body is operable to move backwards with respect to the line (e.g. by sliding or breaking free), thereby causing a relative forward translational movement of the hook with respect to the bait body. Accordingly, when a fish bites onto the bait body in use, the resulting increased pulling force on the bait body relative to the line causes the hook to move/slide forward in the fish's mouth relative to the bait body. This leads to an increased likelihood of the fish being hooked and so thus providing for an increased hook-up-ratio.

### BACKGROUND ART

The present invention relates to a fishing apparatus, and in particular to a bait assembly for a fishing apparatus.

Bait, e.g., for leisure fishing, typically comprises a bait body and a hook (or hooks) which are together attached to a fishing line. The bait is designed to attract a fish such that the fish bites on the bait body and becomes caught on the hook. The bait may be artificial bait, e.g. a lure, or may be dead bait, e.g. using a dead fish as a bait body.

An artificial lure typically comprises a generally elongate lure body having a front end for coupling to a fishing line, and a hook fixedly attached to a body of the lure at a position along its length, e.g. at a trailing (rear) end of the lure body, or at a position midway along the lure body's axis of extent. The hook is typically attached to the lure body in a manner that allows the hook to move freely about its attachment point. For example, a split ring could be used to attach the hook to the lure body. In other examples, the hook can be attached to the lure body in a manner that does not allow it to move about its attachment point. The bait is typically connected to a fishing line via an intermediate trace which is connected to the bait body.

FIG. 1 of the accompanying drawings, schematically shows a simplified example of a conventional lure 101. The lure 101 comprises a trace 104 coupled to a lure body 102. Two hooks 103 are pivotably attached to the lure body 102 at positions along an axis of the generally elongate lure body. The size and detailed design of the lure will depend on the fish sought. A lure body around 10 cm or so in length might be typical. However, longer lure bodies, e.g. up to 50 cm or more, may be used.

In use, the lure 101 is attached to a fishing line (not shown) which is coupled to the lure 101 via the trace 104, and is cast into a body of water. As the lure 101 is in the water, an attracted fish will take hold of the lure 101 in its mouth. In practice the fish will initially gain and maintain a firm grip on the lure body 102 without necessarily becoming caught on the hooks. That is to say, the fish will bite on the lure body and the hooks may simply hang in the fish's mouth cavity, or rest against the inner walls of the fish's mouth, without impaling the fish's flesh. In this situation the hooks might impale the fish as it lets go of the lure body, e.g. because of a loss of interest, or in an attempt to get a better grip. This is because when the fish releases its grip, even if only momentarily, the lure body and attached hooks become free to move in the fish's mouth and the hooks may be pulled into the fish's flesh. This is generally how fish are successfully caught. However, in a not-insignificant number of cases the entire lure might be released from the fish's mouth without the hooks catching on its flesh. Thus the fish escapes. This means the number of fish being caught (“hooked”) can be relatively small compared to the number of fish that take a hold of the bait, i.e. the hook-up-ratio can be low.

In addition to the poor hook-up-ratio, there are other practical problems with conventional lures such as the kind shown in FIG. 1. For example, it can be difficult to remove the fish from the lure once it has been caught. This is because the lure body often can get in the way of an angler's attempt to extricate the hook(s).

Furthermore, an angler may wish to use a number a different types of lure configurations during a single fishing expedition, e.g. lures having differently designed lure bodies which behave differently in the water. This means the angler must carry a plurality of different lures. This often results in frustration as the lures (primarily their hooks) become entangled with one another during transport.

There is therefore a need for a fishing apparatus which provides for an improved hook-up-ratio and which is in practice easier to use than existing designs.

### SUMMARY OF THE INVENTION

According to an aspect of the invention there is provided a bait assembly for fishing comprising a hook coupled to a rearward end of a line; a bait body moveably mounted with respect to the line and arranged so that in normal use a flexible section of the line extends into the bait body (e.g. through an aperture) and a retaining mechanism arranged to bias the bait body in a forward rest position on the line relative to the hook, and operable such that when a pulling force applied between the bait body and the line overcomes the biasing action of the retaining mechanism, the bait body moves backwards with respect to the line, thereby causing a forward translational movement of the hook relative to the bait body.

Thus when a fish bites onto the bait body in use, the resulting increased pulling force on the bait body relative to the line causes the bait body to move backwards on the line such that the hook moves forward in the fish's mouth. This leads to an increased likelihood of the fish being hooked (i.e. of the hook piercing the fish's flesh) and so thus providing for an increased hook-up-ratio.

The forward translational movement of the hook with respect to the bait body may be substantially parallel to an axis of extent of the bait body. The assembly may be such that the hook may, for example, be operable to move forward relative to the bait body by at least a distance selected from the group comprising 1 cm, 2 cm, 3 cm, 4 cm, 5 cm, 6 cm, 7 cm, 8 cm, 9 cm and 10 cm. In some embodiments the hook may be operable to move forward relative to the bait body by at least an amount selected from the group comprising 10%, 20%, 30%, 40%, 50%, 60% and 70% of a length of the bait body along a direction substantially parallel to the movement of the hook.

The retaining mechanism may comprise an extendable element coupled between the line and the bait body (possibly directly, or possibly via a hook, or hook carrier) such that relative movement between the hook and the bait body is associated with an extension of the extendable element. The extendable element may be resilient, e.g. an elastic cord or a spring, or may be non-resilient, e.g. comprising a compressed corrugated tube.

The extendable element may be arranged such that it has one end coupled to the bait body, and another end coupled to the line, and wherein the end coupled to the bait body is rearward of the end coupled to the line.

In other embodiments, the retaining mechanism may comprise a compressible element coupled between the line and the bait body such that relative movement between the hook and the bait body is associated with compression of the compressible element. The compressible element may be a resilient element, e.g. a spring such as a helical spring, or a pair of counter-wound helical springs. Alternatively, the compressible element may be non-resilient, comprising a collapsible corrugated tube.

The compressible element may be arranged with one end coupled to the bait body and another end coupled to the line, and wherein the end coupled to the bait body is forward of the end coupled to the line.

Whether resilient or not, the retaining mechanism may be configured such that there is no energy stored in the retaining mechanism when the bait body is biased in its forward rest position on the line relative to the hook (i.e. the retaining mechanism is not “spring-loaded”). Thus relative movement of the hook with respect to the bait body is provided only by the increased pulling force of the fish and not by any potential energy stored in the assembly. To this extent the retaining mechanism may be considered to be a passive mechanism.

The bait body may be elongate and may include an open channel along at least a part of its length, and wherein a portion of the hook and at least a portion of the retaining mechanism are accommodated within the channel. This can provide for a compact configuration in which the aspects of the assembly are protected from some forms of potential damage or tangling by the bait body. In some embodiments having a channel it may be useful to locate as much of the retaining mechanism and hook(s) (and associated sections of line) within the channel as possible, e.g., such that only the point(s) of the hook(s) protrude out of the channel. This can help, for example, in reducing the chances of a fish clamping the hooks in position against with respect to the lure body as it bites on the bait assembly and so inhibiting the hooks from moving freely relative to the bait body in the desired manner.

In these examples, the translational movement of the hook relative to the bait body may be constrained by the channel.

The bait assembly may further comprise a support member arranged to hold the portion of the hook and/or the at least a portion of the retaining mechanism within the channel. For example, the support member may comprises one or more lengths of semi-rigid (pliable/flexible) material, such as one or more strands of nylon bristle, extending across the channel. The support member may be arranged so as to not extend fully across the channel so that the portion of the hook and/or the at least a portion of the retaining mechanism can pass by the support member if pulled with sufficient force to deform the support member. For example, the support member may comprise an elongate flexible member extending between the inner walls of the channel, but which has been split, e.g. around the middle of the channel, so that with sufficient force the support member can be flexed so that the portion of the hook and/or the at least a portion of the retaining mechanism can pass by.

The hook may be coupled to the line via a hook carrier element, and various different types of hook may be used. For example the hook might have first and second shanks, and furthermore these might be disposed on opposing sides of the hook carrier.

What is more, the bait assembly might further comprise at least one further hook coupled to the line, possibly using a common hook carrier. Thus a multiple-hook bait assembly may be provided. Nonetheless, in some cases an increased catching efficiency (i.e. increased hook-up ratio) associated with embodiments of the invention may be such that an angler considers fewer hooks to be necessary than might otherwise be considered appropriate for a conventional bait assembly in the same fishing context. This may be particularly useful, for example, in catch and release fishing where fewer hooks could lead to easier unhooking of the fish and reduced damage to the fish itself.

The bait body might comprise an artificial lure or a skewer onto which dead bait may be mounted.

The bait body might also comprise at least one of a weight, a buoyancy element, a rattle, an attractor and/or a fin to govern movement of the bait assembly in water as desired for a given fishing application.

The retaining mechanism may be operable to be disconnected such that the bait body becomes free to move with respect to on the line. This can assist in unhooking a fish and allows different bait bodies to be readily interchanged with a common hook and line assembly. The bait bodies and hooks may also be stored separately, thus reducing the risk of tangling.

The bait body may be moveable with respect to the line in that it slideably mounted on the line, or may alternatively be detachably mounted with respect to the line.

### BRIEF DESCRIPTION OF THE DRAWINGS

For a better understanding of the invention, and to show how the same may be carried into effect, reference is now made by way of example to the accompanying drawings, in which:

FIG. 1 shows an example of a standard fishing lure;

FIG. 2A shows a fishing apparatus according to an embodiment of the invention;

FIG. 2B shows the fishing apparatus of FIG. 2A in use as a fish first bites on a main body of the fishing apparatus;

FIG. 2C shows the fishing apparatus of FIGS. 2A and 2B after a hook of the fishing apparatus has moved forwards relative to the main body and has impaled the fish;

FIG. 2D shows the fishing apparatus of FIGS. 2A to 2C with the fish remaining impaled on the hook as the main body is released from its mouth;

FIG. 3A shows a fishing apparatus according to another embodiment of the invention;

FIG. 3B shows another view of the fishing apparatus of FIG. 3A;

FIG. 4 shows a fishing apparatus according to another embodiment of the invention;

FIG. 5A shows a fishing apparatus according to another embodiment of the invention; and

FIG. 5B shows another view of the fishing apparatus of FIG. 5A.

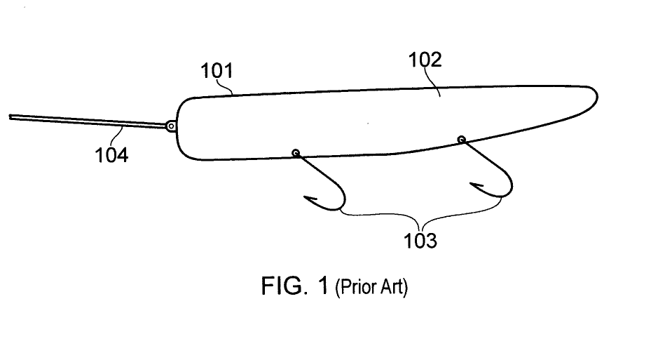

### DETAILED DESCRIPTION

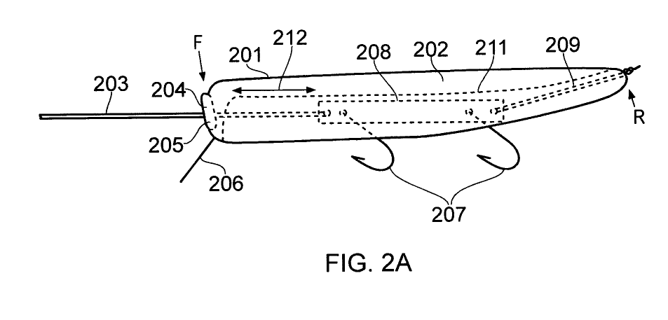

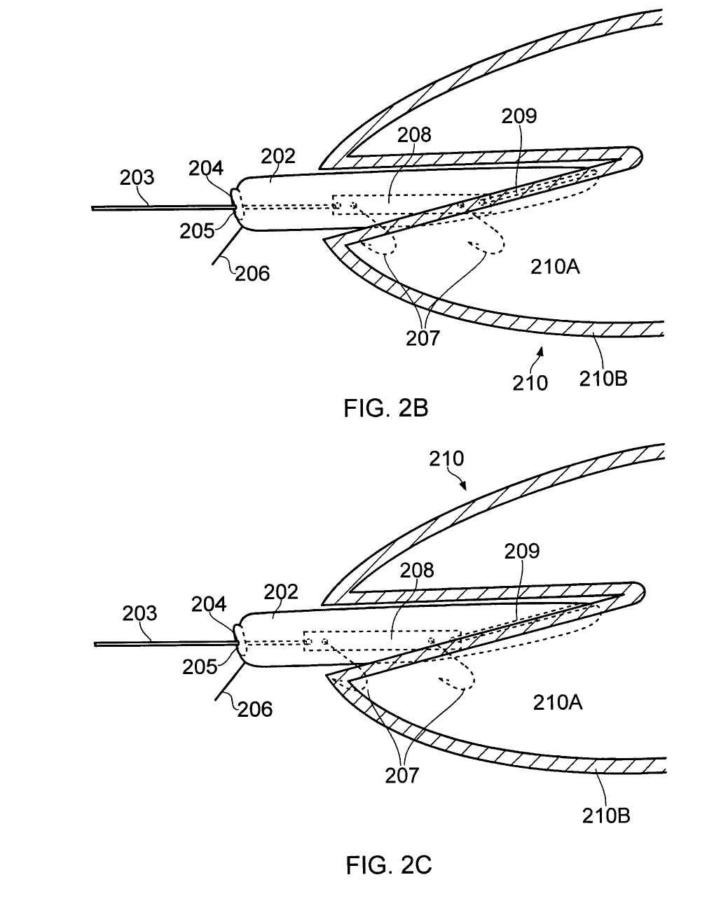

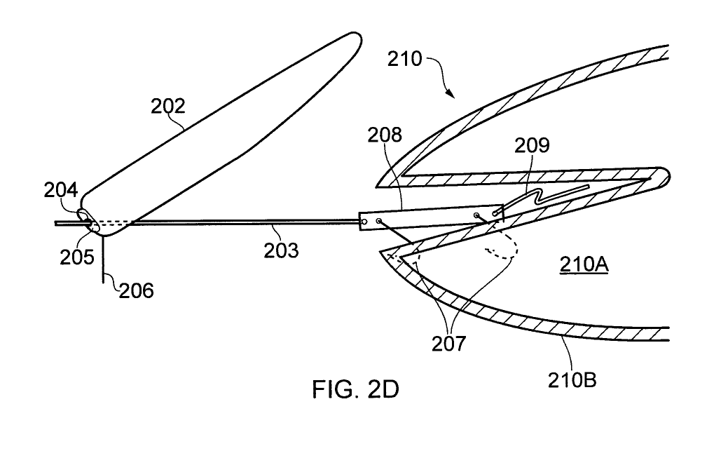

FIG. 2A shows a fishing apparatus 201 according to a first embodiment of the invention. The fishing apparatus 201 comprises a lure body 202 having a forward end (generally indicated at F to the left in FIG. 2A) and a backward end (generally indicated at R in FIG. 2A). The lure body 202 in this example is made from wood and is painted as desired to attract fish, e.g. in a similar manner to how conventional lure might be painted. Other lure body materials could be used, e.g., plastics or metals. The lure body 202 may be weighted so that it sinks to a desired depth, or may be buoyant so that it floats. The overall characteristic lure body size and shape may generally accord with those of conventional lures (i.e. will be selected primarily according to what is considered most likely to attract fishes sought). The example lure body in FIG. 2A is generally elongate having an overall rounded square outer profile, and has a length of around 10 cm and a characteristic width of around 2.5 cm. Other shapes may equally be used, e.g. a generally flat shape.

Unlike conventional lures, the lure body 201 in FIG. 2A is provided with an open channel 211 running along a part of its length (i.e. the lure body has a generally squared U-shape cross-section along at least this part of its length). Within the channel 211 is a hook carrier 208. In this example the hook carrier is a simple strip of metal, e.g. formed of steel or titanium, having holes for attaching various components as described below. The hook carrier has a length that is less than the length of the channel 211 such that it may move forwards and backwards within the channel. The hook carrier 208 in FIG. 2A is shown near to its rearmost position in the channel 211. The hook carrier may move forwards and backwards in the channel over a range schematically indicated by a double-headed arrow 212 in FIG. 2A. The channel 211 and hook carrier 208 lengths in this example are such that the hook carrier (and hence any attached hooks) may slide over around a fifth or so of the length of the lure body. In other examples, smaller or greater ranges of motion may be provided for, e.g. up to around 10%, 20%, 30%, 40%, 50%, 60%, 70% or more of the characteristic length of the lure body.

A forward end of the hook carrier 208 is coupled to a trace 203 extending into the channel 211 in the lure body 202 through an aperture 204 in the forward end of the lure body. Two hooks 207 are attached to the hook carrier 208 in this embodiment. The hooks are conventional fishing hooks, and in this example are free to pivot about their respective points of attachment to the hook carrier (in other examples the hooks may be fixed in position relative to the hook carrier 208, and there may be more or fewer than two hooks).

The hooks 207 are positioned on the hook carrier so that the hook end extends out of the channel 211 and beyond the lure body 202 (i.e. the hook point is outside the lure body). The hook types used could be single shank with single hook as in FIG. 2A. However, double or treble hooks, and/or double shank hooks could equally be used. Using double shank hooks may in some cases allow easier replacement of hooks and easier positioning of the hooks relative to the hook carrier. If double shank hooks are used, their position may be retained relative to the hook carrier by friction between the respective hook shanks and opposing faces of the hook carrier 208. Single or multiple point hooks and hooks of any desired size, either hanging free or retained in position relative to hook carrier may be used.

As noted above, the lure body 202 includes an aperture/opening 204 at the forward end to accommodate the trace 203. The trace 203 is routed through the aperture 204 such that one end of the trace extends outwardly from the forward end of the lure body 202, and the other end of the trace 203 extends into the channel 211 in the lure body 202 where it is coupled to the hook carrier 208. It will be appreciated that the trace 203 could be replaced with conventional fishing line. The end of the trace 203 (or line) that extends forwardly from the forward end of the lure body 202 will be typically coupled to a conventional fishing line (not shown) using a conventional trace-to-line coupling mechanism (not shown). For example, a conventional fishing snap could be used. The trace-to-line coupling mechanism may be larger than the aperture 204 in the lure body 202. The overall length of the trace 203 may be selected by the angler, but might typically be on the order of 10 to 30 cm, for example. A trace is not necessary in all cases as a fishing line may equally be coupled directly to the hook carrier without a trace (or to the hook(s) without a separate carrier). A trace can be useful if there is a concern a fish might bite through a conventional, e.g. nylon, fishing line as it grabs the bait. This is because a trace will generally be formed of wire, e.g. titanium wire. Where a trace is not considered necessary, it may be dispensed with. Thus references throughout this description to a line should be interpreted as meaning a line that might or might not include a trace, unless the context demands otherwise. In some examples a fluorocarbon-based line may be used. This is generally tougher/more hardwearing than conventional nylon line, and may thus allow a trace not to be used even if there is a concern that fish would bite through a conventional line.

A grommet 205 is inserted in the aperture 204 to help reduce damage/chafing of the trace (or conventional line if no trace is used). The grommet 205 in this case is a rubber grommet, but other materials could be used (e.g. plastics/ceramics).

A retaining device/biasing mechanism 209 is provided between the hook carrier 208 and the lure body. In the example shown in FIG. 2A, the retaining device 209 is a length of nominally un-stretched rubber elastic (a spring could equally be used). The elastic is tied to the hook carrier and is removably attached towards the rear end of the lure body (e.g. by seating a knot in the elastic in a V-groove or a slot towards the rear of the lure body). The function of the retaining device is to maintain the hook carrier in a rest position along the axis of the lure body which is towards the rearward end of its extent of movement within the channel 211, while allowing it to move forwards if sufficient force is applied between the hook carrier and the lure body to overcome the retaining force of the retaining device 209. The retaining device 209 is arranged to apply a sufficient retaining force such that when the fishing apparatus is in normal use in water (without a fish attached) the hook carrier is maintained in its rearward rest position relative to the lure body. For example, the retaining mechanism might be arranged such that a force equivalent to a weight of a few ounces to a few pounds (e.g. perhaps on the order of a few Newtons or so) is required to overcome the retaining mechanism and cause the hook assembly (and attached hooks) to move to the forward end of its range of travel within the channel 211. The magnitude of the force required to overcome the retaining force may depend on the nature of the fish sought, e.g. small fish may be fished for using a relatively small lure body with a correspondingly smaller force required to overcome the retaining mechanism.

The lure body 202 can optionally be fitted with a means to govern the movement of the fishing apparatus 201 as it is pulled through water and/or may be fitted with a rattle or other attractor. In the example shown in FIG. 2A, the lure body 202 includes a forward mounted diving vane (fin) 206 that will result in the fishing apparatus 202 typically diving as it is moved through water. Such aspects of the lure may be broadly conventional.

FIGS. 2B-2D schematically show how the fishing apparatus 201 operates in normal use. The fishing apparatus 201 shown in FIG. 2A may be deployed into water in any manner and left to float or sink in the water, possibly at rest or possibly moving, depending on conventional fishing techniques for the fish sought. Thus the assembly shown in FIG. 2A may be coupled to a conventional nylon fishing line (in this example via trace 203) and the nylon fishing line may run to a conventional fishing rod of the angler, either on shore, in a boat or in the water. If, as in this example, the fishing apparatus 201 is fitted with a vane 206, the hook assembly will typically dive as it moves through water (e.g. as water currents pass the bait assembly, or the bait assembly is pulled). A fish attracted to the bait body, e.g. by virtue of its shape/size/colour/motion in the water etc., will typically take a hold of the lure body in its mouth.

FIG. 2B schematically shows a fish 210 that has just closed its mouth about the bait body 202. The fish 210 is shown in highly schematic semi cross-section as comprising a mouth cavity 210A defined by a wall of outer flesh 210B. The fish is also shown in FIG. 2B approaching the lure from the rear. In practice it would more likely approach from the side or from below, but this is not significant to embodiments of the invention. As shown in FIG. 2B, the fish 210 has taken hold of the lure body 202, but neither of the hooks 207 has actually impaled the fish's flesh. This situation is thus equivalent to that discussed above which may arise with conventional lures, and with conventional lures it is the lack of the hook(s) having fully pierced the fish's flesh before the fish releases its grip on the lure that may lead to relatively poor hook-up-ratios.

FIG. 2C is similar to and will be understood from FIG. 2B, but shows the situation at a time shortly after the fish has first bitten the lure body (i.e. shortly after the situation shown in FIG. 2B). The presence of the fish attached to the lure body has led to the retaining force that maintains the hook carrier in its rearward rest position being overcome such that the hooks move forward relative to the lure body under increased tension in the line. This happens since the fish's presence causes an increased pulling force between the lure body and the line coupled to the hooks (in this example via the hook carrier). The exact mechanism by which an increased force between the lure body and the line is applied will depend on the dynamics of the situation at hand, and the fishing technique employed.

For example, in some cases, prior to the fish taking the bait, the bait assembly may be stationary in the water without any tension in the line. Here it may be the action of the fish trying to swim away with the lure body that develops the tension in the line that overcomes the force of the elastic holding the hooks in a rearward position relative to the lure body. In this regard some fish will often turn away or dive. It can thus be helpful for the section of line/trace passing into the bait body. e.g. though the grommet/aperture in the bait body, to be flexible so that the bait body can still slide relative the line if the fish turns sharply with the bait assembly in its mouth. Equally, it may be that the angler identifies a fish has taken the bait, e.g. by noting increased tension on the line, and the retaining force of the elastic may be overcome by the angler giving a jerk on the line (i.e. such that the combined inertia of the lure body and the fish lead to the relative pulling force between the hook(s) coupled to the line and the lure body overcoming the retaining force). In other cases, the line may already be in tension before a fish takes the bait, e.g. due to drag on the bait assembly as it is pulled through the water. Here it may be increased drag (as well as increased inertia) that provides the pulling force between the lure body and the line as the fish takes hold of the lure body. I.e. the hook carrier 208 may move relative to the lure body 202 because the force required to extend the retaining device 209 is less than the force required to move the lure body 202 and the fish 210 together through the water.

Thus FIG. 2C shows the fishing apparatus 201 with the hook carrier 208 and the hooks 207 in a forward position relative to the lure body 202. As discussed above, an increase in tension in the line coupled to the hooks 207 (via the hook carrier 208) has overcome the bias force of the elastic holding the hooks (again via the hook carrier 208) in their respective rearward rest positions, and the hooks have moved forward relative to the lure body. This moves the hooks in the fish's mouth cavity 210A until one or other (or both) pierce the fish's flesh 210B, or the hook carrier reaches the extent of its forward travel (e.g. as defined by the extent of the channel 211). As the hook carrier 208 and the hooks 207 move forward relative to the lure body 202, the hooks 207 will penetrate, or further penetrate (i.e. if the fish is already hooked), the skin and/or flesh of the fish. In FIG. 2C the forward hook (i.e. leftmost in the figure) is shown having moved forward to impale the fish. The fish is now hooked and may be reeled in as usual. Although shown schematically in FIG. 2B as a front hook piercing a front wall of the fish's mouth, this is simply for ease of representations. In practice, any of the hooks in use could equally impale on parts of the fish, e.g. its cheek or the roof of its mouth, as they are moved forwards relative to the lure body under an increase in the relative pulling force between the lure body and the line.

FIG. 2D is similar to and will be understood from FIGS. 2A to 2C, but shows the fish 210 after it has been landed, and the angler is in the process of removing the hook(s) that have impale the fish. To assist in doing this, the elastic 209 may be detached from the rear end of the lure body 202 and the lure body slid up the trace 203. This clears the vicinity of the fish's mouth and allows the angler to more readily unhook the fish. The lure body may move along the trace as far as a stop, e.g. an element attached to the trace that is larger than the aperture 204 in the lure body. The stop mechanism could be the coupling mechanism used to couple the trace and the line, e.g., a fishing snap swivel, for example. Disconnecting the snap swivel could then allow the lure body to be fully removed from the trace. A differently designed lure body could then be attached, e.g. a lure body designed to attract a different type of fish or considered more appropriate for different fishing conditions. Thus a single hook assembly could be used with multiple lures. An angler may find this more convenient than carrying around many lures each having their own hooks.

When the hook(s) 207 have penetrated the skin and/or flesh of the fish 210 during the catching process, the fish may itself attempt to throw the lure body. In doing this the retaining device 209 might detach from the backward end of the lure body 202 and the lure body 202 might be thrown away from the hook carrier 208, and up the trace similar to as shown in FIG. 2D. This does not impact the ability to reel the fish in since the hook(s) to which the line is coupled is (are) already embedded in the fish's flesh. Indeed in some embodiments, the retaining mechanism may be configured in such a way that it is encouraged to detach as the fish struggles. A hooked fish will often try to eject the bait by opening its mouth and shaking its head. If the retaining mechanism is configured in such a way that makes it likely to detach during such a struggle (e.g. by arranging the retaining mechanism so that it will detach relatively easily if subject to forces that are tangential to direction in which the biasing/holding action is applied, or in such a way that the retaining mechanism is severable), it may be flung up the line during a struggle. If a stop mechanism is provided further up the line (which might be, e.g., a snap swivel for coupling a conventional line to a trace section), the inertia of the flung lure body hitting the stop can help force the hook(s) still further into the fish's flesh.

While FIGS. 2A-2D show an embodiment of the invention with two hooks attached to a hook carrier. It will be appreciated that single or multiple hooks could be used that are coupled directly to the trace, or the line, and to the retaining device, without the need for a dedicated hook carrier.

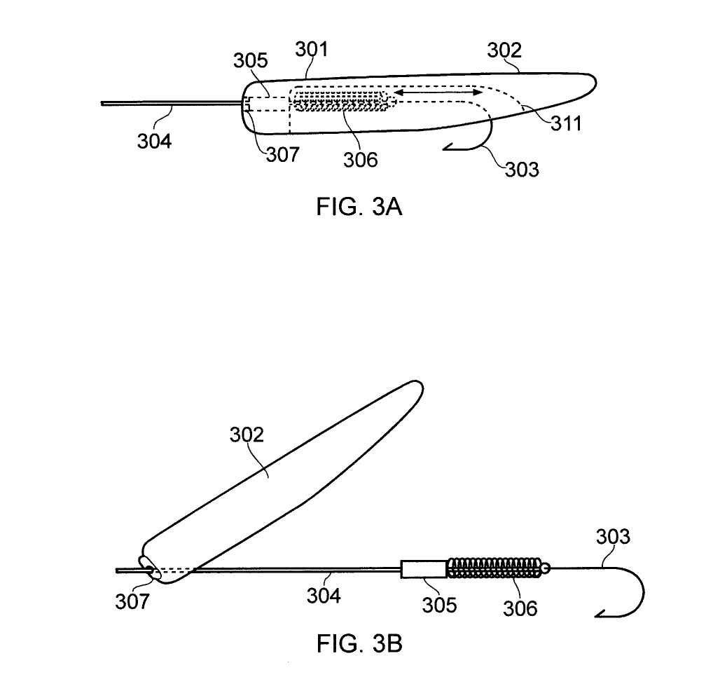

FIG. 3A shows a fishing apparatus 301 according to a second embodiment of the invention. This embodiment differs from the embodiment shown in FIGS. 2A to 2D primarily by using a different retaining device/biasing mechanism. Whereas the example in FIGS. 2A to 2D employs an elastic string, the embodiment shown in FIG. 3A uses a spring. What is more, the spring in FIG. 3A is arranged to operate in compression (rather than extension) when the hooks move forward. Many aspects of the fishing apparatus 301 shown in FIGS. 3A and 3B are similar to and will be understood from the above description of the fishing apparatus 201 shown in FIGS. 2A to 2D.

Thus the fishing apparatus 301 comprises a lure body 302, having a forward and backward end. The forward end of the lure body comprises an aperture 307 arranged to accommodate a friction fit plug 305. The friction fit plug 305 is inserted into the aperture 307 but may be readily removed if desired, as described further below. The friction fit plug 305 further comprises an elongate channel through which a trace 304 extends from the forward end of the lure body 302. As in the embodiment shown in FIG. 2A, there is an open channel 311 (schematically shown in doted outline in FIG. 3A) in the lure body 302. The open channel in the lure body accommodates a bias mechanism, in this case a spring 306 through which the trace is threaded, and a hook 303 (in this example only a single hook 303 is used without a separate hook carrier). The hook 303 is connected to the end of the trace 304 so that tension in the trace causes the hook shank to abut one end (the rearward) end of the spring 306 while the forward end of the spring abuts the friction fit plug 305. In this example, the spring 306 is fixedly attached to the friction plug and the hook at its respective ends. This can help to keep the assembly together when a coupled fishing line is not in tension (or before a fishing line is attached to the trace). However, if this is not desired, the spring may not be attached to either the friction fit plug or the hook.

Similar to the biasing/retaining mechanism provided by the elastic 209 in FIG. 2A, the function of the spring 306 FIG. 3A is to maintain the hook 303 in a rearward rest position along the axis of the lure body, while allowing it to move forwards if sufficient force is applied to overcome the retaining device (i.e. to compress the spring 306). The spring is arranged so as to apply a sufficient retaining force such that when the fishing apparatus moves through water during normal use (without a fish attached) the hook is maintained in its rest position. In this embodiment the trace 304 (or at least a part of the trace in the channel of the lure body) may by stiffer than typical to help retain the hook in a desired position within the channel of the lure body, e.g. so that a part of the hook 303 (i.e. at least the point) extends beyond the lure body 302. A trace used in various embodiments of the invention (including embodiments similar to those shown in FIGS. 2A to 2D and 3A and 3B) may be a composite element. For example, the trace might comprise a section of conventional flexible stranded wire trace (e.g. seven stranded) which is doubled-up and sheathed in plastic (e.g. conventional heat-shrink sheathing). This section may then be tied, or otherwise coupled, to a stiffer single strand wire trace section to which the hook(s) are coupled, or directly to a hook carrier assembly such as shown in FIGS. 2A to 2D, for example. Sections of the trace may, for example, be formed of titanium, e.g. such as memory-flex titanium to reduce potential kinking.

In use the fishing apparatus 301 shown in FIG. 3A operates in a broadly similar fashion as the fishing apparatus 201 described above for the first embodiment of the invention.

Thus, the trace 304 of the fishing apparatus 301 is typically coupled to a conventional fishing line (not shown) using a conventional coupling mechanism, e.g., a conventional fishing swivel. The fishing apparatus 301 may then be deployed in a body of water in a desired manner. Again trim weights, buoyancy elements, guiding fins/vanes, rattles and or attractors may be used as desired. As for the embodiment shown in FIGS. 2A to 2D, the retaining mechanism maintains the hook 303 in its rearward rest position relative to the lure body 302 while awaiting a fish to bite. If a fish takes hold of the lure body, the hook may then be pulled forwards relative to the lure body as the tension in the line overcomes the resistance of the spring 306 to compression. The fish may then be hooked broadly as shown in FIGS. 2B and 2C, even though as before, the lure body itself might not move in the fish's mouth.

FIG. 3B is similar to and will be understood from FIG. 3A, but shows the lure body 302 at a position where it has slid up the trace 304. This is achieved by overcoming the friction fit of the friction plug 305 in the lure body such that the lure body becomes free to slide up the trace. This can again be useful after a fish has been landed and the angler is in the process of removing the hook since the lure body can again be moved from the vicinity of the fish's mouth. (As before, the retaining mechanism may be specifically designed to break free as a fish struggles such that the fish may throw the lure body while remaining hooked.) Also, the lure body may be removed fully from the trace so that a replacement lure body may readily be used with the same hook/biasing mechanism assembly. If the flexibility of being able to move the lure up the trace in this way is not desired, the friction plug may be dispensed with and the spring may be coupled directly to the lure body.

The compression spring 306 in this embodiment could be a conventional coiled spring, for example made of steel. One spring or multiple springs could equally be used. E.g. a pair of counter-wound springs might be used. This could help reduce torsion forces applied between the trace 304 and the hook 303 during compression of the spring, and so reduce rotation of the hook 303 as it moves forward relative to the lure body. It will be appreciated that the spring will return to its non-compressed state if the friction fit plug 305 is released from the lure body 302.

While the embodiment shown in FIGS. 3A and 3B is based on a compression spring, it will be appreciated that a similar embodiment could be based on a non-resilient retaining/biasing mechanism. E.g. a collapsible element may be used instead of compression spring 306. For example, a collapsing corrugated tube might be used as a direct replacement for the spring. When sufficient force is applied (e.g. due to a fish holding onto the lure body), the collapsible element would collapse, allowing the hook to move forwards. The angler might then re-set the collapsible member by extending it manually. A corresponding non-resilient extensible member, e.g. another corrugated element, could likewise be used in place of the rubber elastic 209 in the embodiment shown in FIG. 2A.

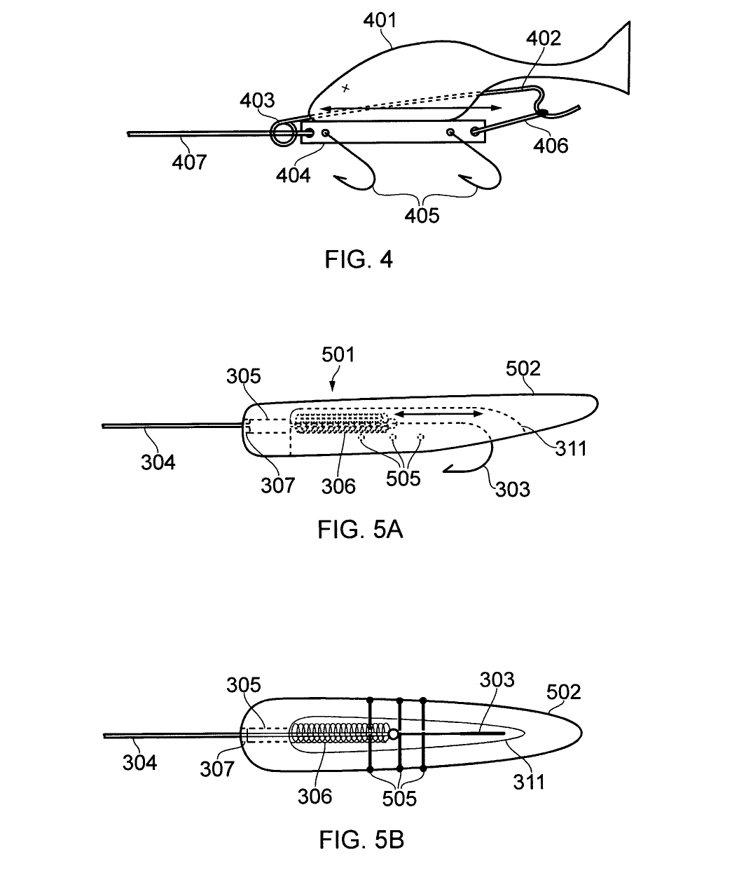

FIG. 4 schematically shows a fishing apparatus according to a third embodiment of the invention. FIG. 4 is broadly similar to and will be understood from the first embodiment of the invention in that it is based on an elastic biasing mechanism. However, the apparatus in this case is designed to be used in conjunction with dead fish bait. Thus whereas a lure body 202 provides the bait body of the fishing apparatus of FIG. 2A to 2D, a bait body generally in the form of a skewer 402 to be driven through a dead fish 401 is employed in the embodiment of FIG. 4.

Thus the fishing apparatus shown in FIG. 4 comprises a trace 407, a hook carrier 404, hooks 405 and a length of elastic 406. These elements are similar to and will be understood from the corresponding elements of FIGS. 2A to 2D. However, rather than being accommodated in a channel in a lure body, the hook carrier 404 in FIG. 4 is arranged parallel to the skewer-like bait body 402. An aperture 403 is provided at a forward end of the skewer 402 (e.g. provided by a bent loop in the skewer, or in other examples by a hole in a vane at the front of the skewer). The trace 407 passes through this aperture 403 in a similar way to the way the trace 203 passes through the aperture 204 in the example shown in FIG. 2A. A rear end (i.e. an end to the right of FIG. 4) of the skewer 402 is provided with a means for releasably attaching the elastic retaining mechanism 406. For example, an end part of the skewer 406 may be bent into a small hook to which the elastic 406 may be tied or looped around. The skewer 402 may be provided by a suitably shaped length of steel wire/rod. It will be appreciated that other rigid materials could be used instead of steel. To help prevent the dead bait 401 from sliding on the skewer 402, a means for attaching dead bait to the skewer may be provided, e.g. a length of conventional fishing line could be threaded through the real bait 401 and coupled to the aperture 403 at the forward end of the elongate member 402.

Although the hook and hook carrier assembly is shown schematically in FIG. 4 as being located outside the fish 401, in practice it may be helpful to locate these in an opening channel in the fish, e.g. in the body cavity of a gutted fish, with only the points of the hooks protruding. In effect this provides the dead bait with a channel which is in many ways similar to the channel 211 of the artificial lure body 202 of the embodiment shown in FIG. 2A. This can help avoid a fish clamping the hooks and/or hook carrier against the side of the dead bait 401 as it bites on it and so preventing the hooks from moving relative to the bait body in the desired manner.

In use, the angler first prepares the bait assembly by running the skewer 402 through the (generally gutted) dead bait 401, and, if desired, secures the skewer to the dead bait in an appropriate manner. The angler may then pass the free end of the trace 407 through the aperture 403 in the skewer 402 for attachment to a section of conventional fishing line via a snap swivel. The hook carrier may then be located in a body cavity of a gutted dead bait and the elastic 406 (or other retaining mechanism) attached to the pointed end of the skewer. The hook(s) may then be arranged so that their point(s) are outside the bait body, but with the majority of the bait assembly remaining hidden within the dead bait. In some embodiments there may be a wish to provide a mechanism for helping keep the relevant parts of the assembly within the fish. For example, where the fish has been gutted, the assembly could be held in place by applying one or more stitches to close the gut cavity. For example, a length of copper wire may be threaded through the fish body and twisted round to at least partially close the cavity.

The elastic 406 maintains the hook carrier 404 and associated hooks 405 at a rearward rest position relative to the bait body skewer 402 and associated dead fish bait 401. The fishing apparatus shown in FIG. 4 may then be used in a manner that is broadly similar to that described above for the first embodiment, as shown in FIGS. 2A-2D.

It will be appreciated that embodiments of the invention which are similar to that shown in FIG. 4 could also be based on a generally conventional soft-bodied lure (e.g. a rubberised lure body comprising a collar and tentacles or having a generally fish-like shape) instead of dead bait. E.g. a skewer similar to that shown in FIG. 4 could instead be driven through a soft-bodied artificial lure (either through an opening designed into the lure, e.g. a collar, or by piercing the material comprising the lure) instead of through a dead fish.

It will also be appreciated that while the above examples have focussed on a lure body that is slideably mounted with respect to the line, other forms of moveable mounting may be employed. For example, in some examples the retaining mechanism may be a detachable/severable mechanism such that the bait body is operable to break free of the line when the holding force provided by the detachable retaining mechanism is overcome. A separate cord (normally slack) may be provided between the bait body and the line so that when the bait body breaks free of the line it is not lost.

FIG. 5A shows side view of a fishing apparatus 501 according to another embodiment of the invention. FIG. 5B shows a view of the fishing apparatus 501 of FIG. 5A as viewed from below (for the orientation shown in FIG. 5A). This embodiment is similar to, and will be understood from, the fishing apparatus 301 shown in FIGS. 3A and 3B. Elements of the fishing apparatus 501 shown in FIGS. 5A and 5B which correspond with elements of the fishing apparatus 301 shown in FIGS. 3A and 3B are identified by the same reference numerals and will be understood from the above description. However, the fishing apparatus 501 of FIGS. 5A and 5B differs from that shown in FIGS. 3A and 3B in that it includes additional support members 505.

The support members are arranged to maintain parts of the hook, line and/or hook carrier assembly within the open channel 311 in a releasable manner. This can be helpful to assist in maintaining the apparatus in the configuration shown in FIG. 5A (i.e. with only the tip of the hook exposed from the channel). For example, referring to FIG. 3A, it is possible in some circumstances for the hook and related assembly to sag/droop so that more of the hook, and also possibly parts of the spring 306 hang out of the channel. In some cases this might impact the effectiveness of the mechanism, e.g. if a fish were to bite the bait body in such a way as to clamp the depending spring against the bait body, thereby impeding its translational movement. It can therefore be beneficial in some cases to provide a support mechanism to hold the relevant portions of the hook/spring in the channel 311, such as shown in FIG. 5A.

In principle the support members 505 could be rigid. For example, they might comprise a solid pin extending fully across the channel 311 and suitably fixed in the walls of the bait body that define the channel 311. However, in this case the hook/spring assembly would be fixed in place, and could not readily for example, come apart from the bait body a shown in FIG. 3B. Accordingly, the support member 505 in this example comprises one or more semi-rigid elongate members that do not extend fully across the channel 311. In particular, each of the three support members 505 used in this example comprises a length of nylon bristle fixed to both sides of the channel 311, but which has been cut around its middle after installation. This has been found to provide sufficient support to hold the hook/spring in the channel 311 during normal use, but to allow the hook/spring assembly to move past the support members when sufficient force is applied to flex the bristles out of the way. Thus the hook assembly is supported in position in normal use, but is able to break free of the channel 311 (similar to as shown in FIG. 3B) and also to move translationally within the channel without significant impedance.

The number of support members (and their locations) can readily be chosen according to the amount of support required to hold the hook assembly in the desired place for normal use. For example, a relatively heavy hook assembly having multiple large hooks may require more and/or stiffer support elements than a relatively lighter hook assembly.

It will be appreciated that other designs of hook carrier from those described above could equally be used. For example, conventional fishing hooks have eyelets for attachment. In some embodiments the hook carrier may comprise a rod, e.g. a brass rod, having a diameter that allows it to be threaded through the eyelet(s) of the hook(s) to be used. The hook(s) may be maintained in position on the brass rod by stops placed either side of hook(s) at the desired positions. The stops may, for example, be brass rings having an outer diameter greater than the diameter of the hook eyelet(s), and which are threaded onto the brass rod and fixed at the desired locations, e.g. by soldering. Thus the hook(s) are in effect sandwiched between respective pairs of stops. This allows the hooks to spin freely about the brass rod, while limiting their lateral movement. The brass rod may be tubular and may be attached to the trace/line (e.g. made of wire, nylon or fluorocarbon) by having the trace/line pass through the tube and having a clamp/crimp or stop knot arranged to retain the hook carrier. In this way the hook carrier need not be attached at its forward end (relative to the line), but may in effect be pulled from the back via the crimp or stop knot acting on the back of the tube. To help reduce the chance of the carrier/hook assembly riding up the trace/line, an in-line stopper may be provided, e.g. formed from a short section of tube threaded on to the trace with a cork stopper slotted to accommodate the trace. This arrangement can also be used to help hold the spring in place.

In some other embodiments the hook carrier may comprise one or more what might be termed “dumbbell” hook assemblies separated with stiff plastic tubing. Each dumbbell hook assembly may be fabricated by threading the small diameter tip of a bootlace ferrule through the eyelet of a hook and inserting the small diameter tip of a smaller bootlace ferrule into the small diameter tip of the first bootlace ferrule and fixing with solder. The bootlace ferrules may be selected such that the smaller diameter tip of each of the ferrules can pass through the eyelet of the hook to be mounted, and the larger diameter end of each of the bootlace ferrules is large enough not to pass through the eyelet of the hook to be mounted. Thus a hook may be retained on the dumbbell assembly, but able to swing freely. One or more dumbbell hook assemblies may be used and may be spaced by spacer tubes, e.g. made of plastic, which are threaded onto the line/trace in series with the one or more dumbbell hook assemblies. A clamp/crimp or stop knot may again be used to retain the hook carrier on the line/trace. To help reduce the chance of the dumbbell hook assemblies and spacers riding up the trace/line, an in-line stopper may be provided, e.g. formed from a short section of tube threaded on to the trace with a cork stopper slotted to accommodate the trace. Again this can also be used to help hold the spring in place.

It will be appreciated that bait assemblies according to embodiments of the invention could incorporate various features of the above described embodiments in different combinations. For example, while the support structures of FIGS. 5A and 5B are described in the context of a bait assembly in which the biasing mechanism is a forward-mounted spring, similar supports may also be used in a bait assembly in which the biasing mechanism is based on rear-mounted elastic (e.g. such as shown in FIG. 2A.

Thus a bait assembly for fishing, e.g. leisure fishing, is described. The bait assembly comprises a hook coupled to a rearward end of a line. A bait body is slideably or detachably mounted with respect to the line. The bait body may comprise an artificial lure, or may comprises a skewer onto which dead bait may be mounted. A retaining mechanism is arranged between the bait body and the line to bias the bait body in a forward position on the line relative to the hook. Thus when a pulling force is applied between the bait body and the line which overcomes the biasing action of the retaining mechanism, the bait body is operable to move backwards with respect to the line (e.g. by sliding or breaking free), thereby causing a relative forward translational movement of the hook with respect to the bait body. Accordingly, when a fish bites onto the bait body in use, the resulting increased pulling force on the bait body relative to the line causes the hook to move/slide forward in the fish's mouth relative to the bait body. This leads to an increased likelihood of the fish being hooked and so thus providing for an increased hook-up-ratio.

1. A bait assembly for fishing comprising:
a hook coupled to a rearward end of a line;
a bait body moveably mounted with respect to the line and arranged so that in normal use a flexible section of the line extends into the bait body, and
a retaining mechanism arranged to bias the bait body in a forward rest position on the line relative to the hook, and operable such that when a pulling force applied between the bait body and the line overcomes the biasing action of the retaining mechanism, the bait body moves backwards with respect to the line, thereby causing a forward translational movement of the hook relative to the bait body.

2. A bait assembly according to claim 1, wherein the forward translational movement of the hook with respect to the bait body is substantially parallel to an axis of extent of the bait body.

3. (canceled)

4. (canceled)

5. A bait assembly according to claim 1, wherein the retaining mechanism comprises an extendable element coupled between the line and the bait body such that relative movement between the hook and the bait body is associated with an extension of the extendable element.

6. A bait assembly according to claim 5, wherein the extendable element is resilient.

7. A bait assembly according to claim 6, wherein the extendable element comprises an elastic cord and/or a spring.

8. (canceled)

9. (canceled)

10. A bait assembly according to claim 5, wherein the extendable element has one end coupled to the bait body and another end coupled to the line, and wherein the end coupled to the bait body is rearward of the end coupled to the line.

11. A bait assembly according to claim 1, wherein the retaining mechanism comprises a compressible element coupled between the line and the bait body such that relative movement between the hook and the bait body is associated with compression of the compressible element.

12. A bait assembly according to claim 11, wherein the compressible element is a resilient element.

13. A bait assembly according to claim 12, wherein the compressible element comprises a spring.

14. (canceled)

15. (canceled)

16. A bait assembly according to claim 11, wherein the compressible element is a non-resilient element.

17. A bait assembly according to claim 11, wherein the compressible element has one end coupled to the bait body and another end coupled to the line, and wherein the end coupled to the bait body is forward of the end coupled to the line.

18. A bait assembly according to claim 17, wherein the bait body is elongate and includes an open channel along at least a part of its length, and wherein a portion of the hook and at least a portion of the retaining mechanism are accommodated within the channel.

19. A bait assembly according to claim 18, wherein the translational movement of the hook relative to the bait body is constrained by the channel.

20. A bait assembly according to claim 18, further comprising a support member arranged to hold the portion of the hook and/or the at least a portion of the retaining mechanism within the channel.

21. A bait assembly according to claim 20, wherein the support member comprises a length of semi-rigid material extending across the channel and/or a nylon bristle.

22. (canceled)

23. (canceled)

24. (canceled)

25. A bait assembly according to claim 1, wherein the hook is coupled to the line via a hook carrier element.

26. (canceled)

27. (canceled)

28. (canceled)

29. A bait assembly according to claim 1, wherein the bait body comprises a skewer for running through an item of dead bait or a soft-bodied artificial lure.

30. (canceled)

31. A bait assembly according to claim 1, wherein the retaining mechanism is operable to be disconnected such that the bait body becomes free to slide on the line.

32. (canceled)

33. A bait assembly according to claim 1, wherein the retaining mechanism is detachably coupled between the bait body and the line.

34. A bait assembly according to claim 1, wherein the bait body is slideably mounted to the line and/or detachably mounted to the line.

35. (canceled)

36. (canceled)
